(19) United States
(12) Patent Application Publication
(10) Pub. No.: US 2026/0187079 A1
(43) Pub. Date: Jul. 2, 2026

(54) SEARCH DEVICE, SEARCH METHOD, AND RECORDING MEDIUM

(71) Applicant: Rakuten Group, Inc., Tokyo (JP)

(72) Inventor: Wu HUANG, Tokyo (JP)

(21) Appl. No.: 19/412,853

(22) Filed: Dec. 9, 2025

(30) Foreign Application Priority Data
Dec. 27, 2024 (JP) 2024-232908

(51) Int. Cl. G06F 16/2457; G06F 16/28

(52) U.S. Cl. CPC G06F 16/2457; G06F 16/285

(57) ABSTRACT

A search device includes a recorder to record entered search conditions, an acquirer to acquire, from among the recorded search conditions, a search condition that satisfies a latest condition, an extractor to extract, from new transaction targets newly registered in a database, a transaction target that matches any of the acquired search conditions, and a notifier to determine whether or not the extracted transaction target satisfies a notification condition, when determining that the notification condition is satisfied, notify the user of the extracted transaction target, and when a determination is made that the notification condition is not satisfied, repeatedly execute a series of processes including relaxing the latest condition and acquiring the search condition, and extracting the transaction target that matches any of the search conditions, until a determination is made that the notification condition is satisfied.

### CROSS-REFERENCE TO RELATED APPLICATIONS

This application claims the benefit of Japanese Patent Application No. 2024-232908, filed on Dec. 27, 2024, the entire disclosure of which is incorporated by reference herein.

### FIELD OF THE INVENTION

The present disclosure relates to a search device, a search method, and a recording medium.

### BACKGROUND OF THE INVENTION

Technologies for providing various types of information to users have been known. For example, Unexamined Japanese Patent Application Publication No. 2002-108352 discloses a music data distribution device that extracts music titles corresponding to a user-specified favorite artist or genre from newly released songs that are newly registered in a music database, and distributes update information representing the extracted titles or music data of the extracted titles read from the music database.

### SUMMARY OF THE INVENTION

The above music data distribution device distributes the update information and the music data for the titles that meet user-specified conditions among the newly released songs. However, when the user's interests change after the conditions have been specified, the user needs to add new conditions or modify the specified conditions each time, which may result in increased burden. Furthermore, when the user fails to appropriately manage the specified conditions in accordance with the changes in the user's interests, there arises a difficulty in that information relevant to the user's most recent interests cannot be notified. Thus, from the viewpoint of ensuring appropriate notification of newly added information that is likely to be of interest to the user, there remains room for improvement.

The present disclosure has been made in view of the above circumstances, and an objective of the present disclosure is to provide a search device, a search method, and a recording medium capable of ensuring more appropriate notification of newly added information that is likely to be of interest to users.

In order to solve the above-described difficulties, the present disclosure provides a search device for searching for a transaction target that matches search conditions entered by a user, from among a plurality of transaction targets registered in a database, the search device including:
at least one processor configured to
   record the entered search conditions,
   acquire, from among the recorded search conditions, a search condition that satisfies a latest condition for acquiring predetermined search conditions entered most recently,
   extract, from new transaction targets newly registered in the database, a transaction target that matches any of the acquired search conditions,
   determine whether or not the extracted transaction target satisfies a notification condition that includes a minimum number of the transaction targets,
   when determining that the notification condition is satisfied, notify the user of the extracted transaction target, and
   when determining that the extracted transaction target does not satisfy the notification condition, repeatedly execute a series of processes including relaxing the latest condition and acquiring the search conditions and extracting a transaction target that matches any of the search conditions, until a determination is made that the extracted transaction satisfies the notification condition.

The present disclosure can provide a search device, a search method, and a recording medium capable of ensuring more appropriate notification of newly added information that is likely to be of interest to a user.

### BRIEF DESCRIPTION OF DRAWINGS

FIG. 1 is an explanatory diagram illustrating cooperation between a search device and another device;

FIG. 2 is a diagram illustrating an example of an input screen for entering search conditions displayed on a terminal;

FIG. 3 is an explanatory diagram illustrating a functional configuration of the search device;

FIG. 4 is a diagram illustrating an example of a search condition table stored in a search condition storage illustrated in FIG. 3;

FIG. 5 is a diagram illustrating an example of a database illustrated in FIG. 3;

FIG. 6 is a diagram illustrating an example of newly added information generated by a notifier illustrated in FIG. 3;

FIG. 7 is an explanatory diagram illustrating a physical configuration of a search device;

FIG. 8 is a flowchart of a search condition recording process by the search device; and

FIG. 9 is a flowchart of a notification process by the search device.

### DETAILED DESCRIPTION OF THE INVENTION

A search device, a search method, and a recording medium according to embodiments of the present disclosure are described in detail with reference to the drawings. The same or corresponding parts in the drawings are designated by the same reference signs.

In the present embodiment, a search device that provides information related to real estate properties described as an example. For example, the search device is also applicable to provision of information related to movable properties, real estate, and services that are subject to transactions, such as products sold via shopping or auction websites, accommodations or travel plans offered through reservation websites, and content such as videos, electronic books, and games distributed via streaming websites. Accordingly, the present embodiment is provided for illustrative purposes and is not intended to limit the scope of the present disclosure. Therefore, embodiments in which some elements or all elements of these embodiments are replaced with equivalent elements by one skilled in the art can also be employed, and such embodiments are also included within the scope of the present disclosure.

### Overall Configuration

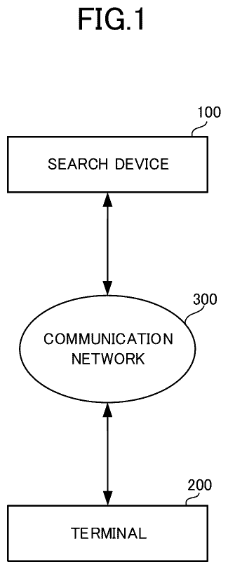

FIG. 1 is an explanatory diagram illustrating cooperation between a search device 100 and another device. Hereinafter, a description is given with reference to this drawing. As illustrated in FIG. 1, the search device 100 according to an embodiment of the present disclosure is communicatively connected to a terminal 200 via a communication network 300. Although one terminal 200 is illustrated in FIG. 1, the number of applicable terminals 200 is not limited thereto, and a plurality of terminals 200 may be applied.

The search device 100 includes one or a plurality of server computers. The search device 100 provides an information provision service. In the information provision service, the search device 100 searches for property information of real estate properties that match search conditions entered by a user from a database that stores property information of real estate properties to be provided, and provides the searched property information of the real estate properties to the user. The properties for which information is provided may include, for example, residences (detached houses, apartment units, or condominium units, etc.) and offices. The properties for which information is provided may also include, for example, newly built properties, pre-owned properties, and rental properties.

The search device 100 records the search conditions entered by the user. At a predetermined timing, the search device 100 acquires, from a history of the recorded search conditions, search conditions that satisfy a latest condition defining the number of most recently input search conditions to retrieve. The search device 100 searches for property information of real estate properties that match the acquired search conditions from among real estate properties newly registered in a database. The search device 100 determines whether or not the searched real estate properties satisfy a notification condition including a minimum number of the real estate properties. When determining that the searched real estate properties satisfy the notification condition, the search device 100 notifies the user of newly added information including the property information of the searched real estate properties.

When determining that the searched real estate properties do not satisfy the notification condition, the search device 100 relaxes the latest condition (increases the number to retrieve), reacquires the search conditions that satisfy the relaxed latest condition, and searches for the property information of the real estate properties that match the acquired search conditions. The search device 100 repeatedly executes, until a determination is made that the re-searched real estate properties satisfy the notification condition, a series of processes including relaxing the latest condition, acquiring the search conditions, and searching for the real estate properties.

The terminal 200 is an information terminal (i.e., a computer), such as a smartphone, a tablet, or a personal computer (PC), for use by a user of the information provision service, and is capable of bidirectional communication with the search device 100 via the communication network 300.

For example, an application for using the information provision service may be installed on the terminal 200. The user can launch the application to access the search device 100, input search conditions, view property information matching the search conditions, and view newly added information transmitted from the search device 100. Alternatively, the user may launch a browser (browser application) installed on the terminal 200 to access the search device 100 and use the information provision service.

The terminal 200 receives input of search conditions from the user and transmits a search query to the search device 100 via the communication network 300 to instruct a search for Real Estate Properties.

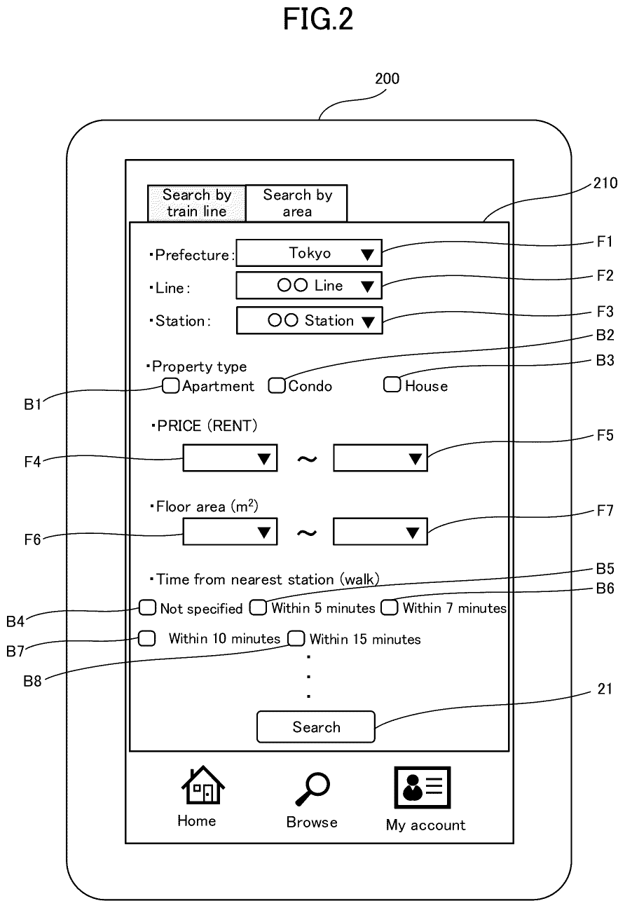

An example of an input screen for entering search conditions is illustrated in FIG. 2. As illustrated, an input screen 210 includes pull-down forms F1 to F7 and buttons B1 to B8 for entering search conditions, and a search button 21 for instructing a search. When the user enters at least one of the search items via the pull-down forms F1 to F7 or the buttons B1 to B8 and clicks the search button 21, the terminal 200 generates a search query including the search conditions entered by the user and transmits the search query to the search device 100. The input screen 210 may be configured in advance to include required input items and optional input items. For example, prefecture, railway line, and station name may be required input items, while other items may be optional.

Returning back to FIG. 1, the communication network 300 can include various types of networks. Examples of the communication network 30 include a local area network (LAN), a wide area network (WAN) such as the Internet, a telecommunication network such as a public switched telephone network (PSTN), a wireless network, a public switched network, a satellite network, a cellular network, a public land mobile network (PLMN), a metropolitan area network (MAN), a private network, an ad hoc network, an intranet, a fiber optic-based network, and a combination of these or other types of networks.

### Functional Configuration of Search Device

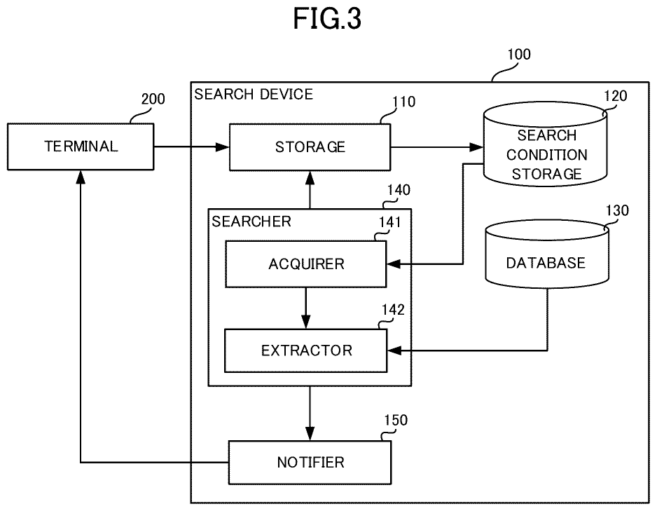

Next, the functional configuration of the search device 100 is described with reference to FIG. 3. The search device 100 includes a recorder 110, a search condition storage 120, a database 130, a searcher 140, and a notifier 150.

The recorder 110 records search conditions entered by the user during a search. Specifically, upon reception of the search query from the terminal 200, the recorder 110 records the search conditions included in the search query in the search condition storage 120 in association with a user ID of the user who owns the terminal 200 and a date and time when the search based on the received search query is performed.

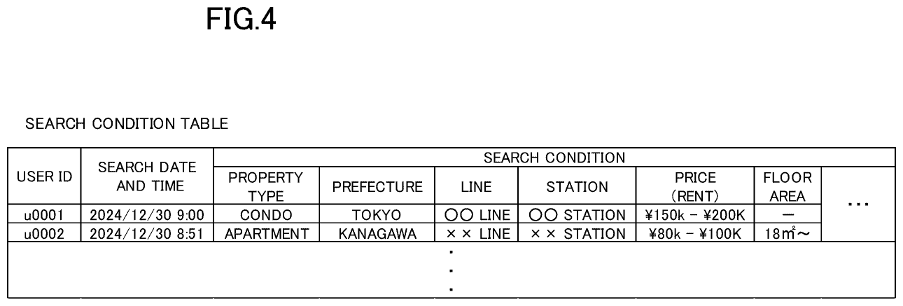

The search condition storage 120 stores a search condition table indicating a history of search conditions previously entered by the user. Here, an example of the search condition table is illustrated in FIG. 4. As illustrated, the search condition table includes a “user ID” uniquely identifying the user, a “search timestamp” indicating when the search is performed, and “search conditions” entered by the user. The search conditions may include items, such as property type, prefecture, railway line, station name, time from the nearest station, price (rent), and floor area. The types of items included in the search conditions and the combination thereof are optional, and may further include other items such as building age, floor plan, floor level, equipment information, availability of parking or bicycle storage, possibility of pet ownership, and possibility of musical instrument use.

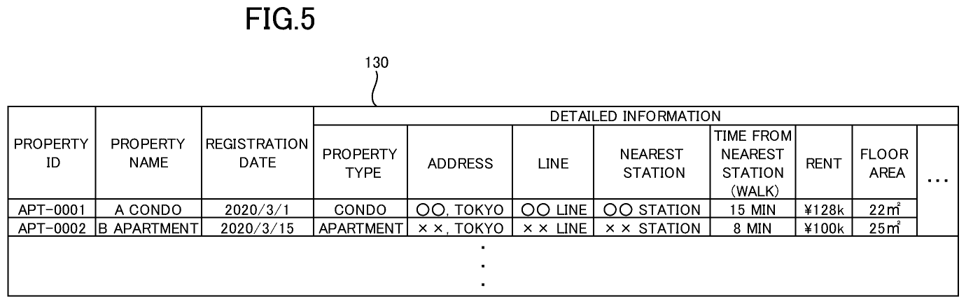

The database 130 stores information related to transaction targets. Here, an example of the database 130 is illustrated in FIG. 5. As illustrated, the database 130 includes a “property ID” that uniquely identifies the real estate property as a transaction target, a “property name” indicating the name of the property, a “registration date” indicating the date of registration of the property, and “detailed information” indicating detailed information of each real estate property. The detailed information may include items such as property type, property address, railway line, nearest station, time from the nearest station, price, and floor area. The types of items included in the detailed information and the combination thereof are optional, and may further include other items similar to those in the search condition table illustrated in FIG. 4, such as building age, floor plan, floor level, equipment information, availability of parking or bicycle storage, possibility of pet ownership, and possibility of musical instrument use. The database 130 may also store property images, which are photographs of the interior and exterior of the real estate properties, and floor plan images.

Returning to FIG. 3, the searcher 140 searches for transaction targets based on a search query received from the terminal 200. Specifically, the searcher 140 extracts, from the database 130 illustrated in FIG. 5 as an example, property information of real estate properties that match the input search conditions, based on the search conditions included in the search query (such as prefecture, line name, station name, and time from the nearest station).

The searcher 140 includes an acquirer 141 and an extractor 142, and searches for transaction targets for user notification from among the transaction targets newly registered in the database 130.

At a preset timing, the acquirer 141 acquires, for each user, search conditions that satisfy a latest condition defining the number of most recently entered search conditions to retrieve, from the history of search conditions recorded in the search condition table, as illustrated in FIG. 4. For example, the acquirer 141 may acquire search conditions at regular intervals such as daily, every three days, or weekly, or may acquire search conditions at the timing when new property information is added to the database 130. For example, with the number to retrieve set to 3 in the latest condition, the acquirer 141 acquires, for each user, three search conditions in order from the most recent search timestamp.

The extractor 142 extracts, for each user, transaction targets that match the search conditions acquired by the acquirer 141 from among the transaction targets newly registered in the database 130. Specifically, the extractor 142 refers to the database 130 illustrated in FIG. 5 as an example, and extracts property information of real estate properties whose registration date of the property information is on and after the date and time of the last notification of the newly added information. That is, the extractor 142 extracts property information newly registered since the date and time of the last notification of the newly added information. Next, the extractor 142 extracts, for each user, property information of real estate properties that match the search conditions acquired by the acquirer 141 from among the extracted real estate properties. The above-mentioned notification date and time may be the search timestamp in the search condition table, as illustrated in FIG. 4.

The notifier 150 notifies the user of newly added information including information related to the transaction target extracted by the extractor 142. Specifically, the notifier 150 determines whether or not the extraction result satisfies a preset notification condition. The notification condition includes a minimum number of real estate properties extracted by the extractor 142. The notifier 150 determines that the extraction result satisfies the notification condition when the number of extracted properties is equal to or greater than the minimum number (e.g., one).

When determining that the notification condition is satisfied, the notifier 150 generates newly added information including the property information of the real estate properties extracted by the extractor 142 and transmits the generated newly added information to the terminal 200 via any method such as email, messaging app, in-app notification, or push notification.

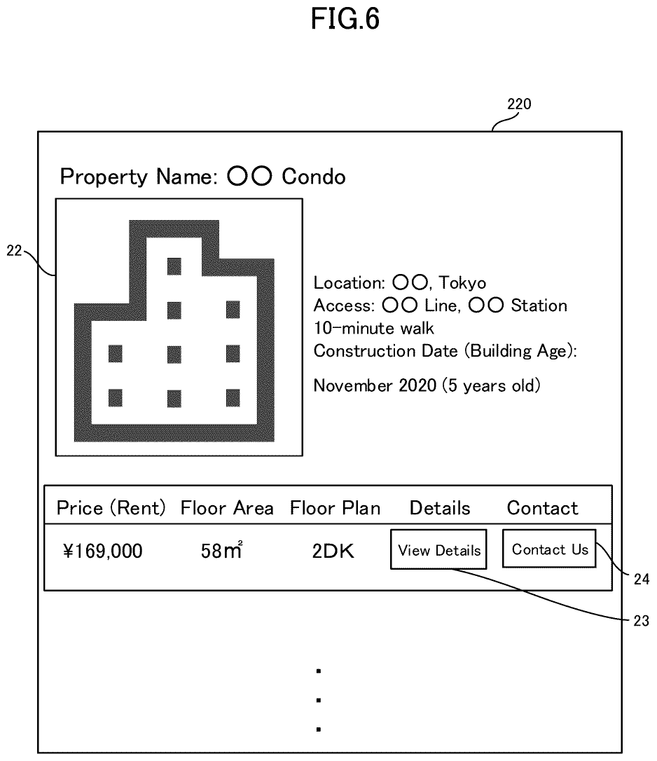

Here, an example of the newly added information generated by the notifier 150 is illustrated in FIG. 6. As illustrated, the newly added information 220 may include, for example, information for the extracted real estate property including an exterior image 22 and basic information (location, railway line, nearest station, time from the nearest station, construction date (building age), price (rent), floor area, floor plan, etc.), a link 23 to a detail page displaying detailed information for each property, and a link 24 to a contact page for inquiries to the real estate agency handling the property.

When determining that the real estate property extracted by the extractor 142 does not satisfy the notification condition, the notifier 150 notifies the acquirer 141 and the extractor 142 of the determination. The acquirer 141 relaxes the latest condition and reacquires a search condition that satisfies the relaxed latest condition. For example, the acquirer 141 increases the number of latest conditions to retrieve from 3 to 5, and reacquires the search condition from the search condition table illustrated in FIG. 4. Then, the extractor 142 extracts property information of the real estate property that matches the reacquired search condition from the database 130 illustrated in FIG. 5.

Until determining that the real estate property extracted by the extractor 142 satisfies the notification condition, the notifier 150 causes the acquirer 141 and the extractor 142 to repeatedly perform a series of processes, which are relaxation of the latest condition and acquisition of the search condition by the acquirer 141, and extraction of the real estate properties by the extractor 142. The notification condition may include a upper limit of the number of repetitions to repeatedly execute the series of these processes, and the notifier 150 may determine not to notify the user of newly added information when the number of repetitions reaches the upper limit.

### Physical Configuration of Search Device

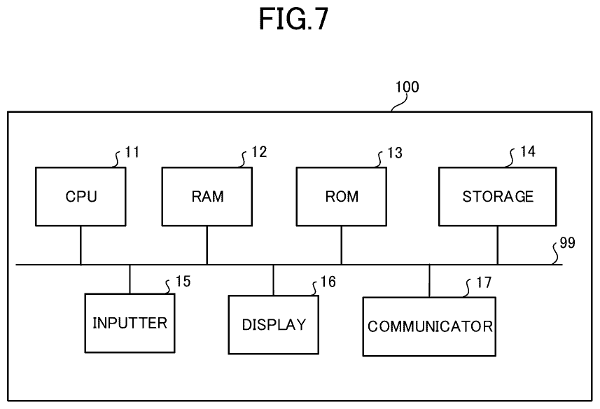

The search device 100 having the above-described functional configuration physically includes, as illustrated in FIG. 7, a central processing unit (CPU) 11 that performs processing in accordance with a program, a random access memory (RAM) 12 that is a volatile memory, a read only memory (ROM) 13 that is a non-volatile memory, a storage 14 that stores data, an inputter 15 that receives input of information, a display 16 that visualizes and displays information, and a communicator 17 that performs transmission and reception of information, and the foregoing components are connected to one another via an internal bus 99.

The CPU 11 performs various types of processing by reading a program stored in the storage 14 into the RAM 12 and executing the program. The CPU 11 executes, as main functions provided by the program, various types of processing by the recorder 110, the searcher 140, the acquirer 141, the extractor 142, and the notifier 150.

The RAM 12 is used as a work area for the CPU 11. The ROM 13 stores a control program, a basic input output system (BIOS), and the like that the CPU 11 executes for basic operation of the search device 100.

The storage 14 includes a hard disk drive, stores a program to be executed by the CPU 11, and stores various types of data to be used in execution of the program. The storage 14 functions as the search condition storage 120 and the database 130.

The inputter 15 is a user interface including a keyboard, a mouse, a communication device, and the like. The display 16 is a display device displaying information visually, such as a liquid crystal display or an organic electro luminescence (EL) display.

The communicator 17 is a network termination device or a wireless communication device connected to a network, and a serial interface or a local area network (LAN) interface connected to the network termination device or the wireless communication device.

### Search Condition Recording Process

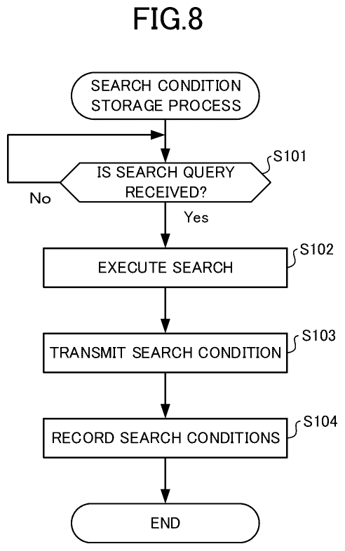

Next, the operation of the search device 100 is described with reference to the drawings. FIG. 8 is a flowchart illustrating the flow of the search condition recording process executed by the search device 100. In the search condition recording process, the search device 100 performs a search based on a search query transmitted from the terminal 200 and records the search condition included in the search query.

The searcher 140 accepts the search query from the terminal 200 and determines whether the search query has been received (step S101). Specifically, the user operates the terminal 200 to start an information-providing application pre-installed on the terminal 200 and accesses the input screen 210 for entering the search condition, as illustrated in FIG. 2. On the input screen 210, the user enters a condition for at least one of items and clicks a search button 21 to instruct execution of the search. The terminal 200 generates a search query including the entered search condition and a user ID, and transmits the search query to the search device 100.

When the searcher 140 receives the search query from the terminal 200 (Yes in step S101), the process proceeds to step S102. On the other hand, when the searcher 140 does not receive the search query from the terminal 200 (No in step S101), the searcher 140 waits for the search query.

In step S102, the searcher 140 performs a search process based on the search query received in step S101 (step S102). Specifically, the searcher 140 extracts, from a database 130, property information of real estate properties that match the search condition included in the search query, as illustrated in FIG. 5.

Next, the searcher 140 transmits the search result to the terminal 200 (step S103). The searcher 140 generates a search result page showing a list of property information of real estate properties extracted in step S102. The searcher 140 transmits a uniform resource locator (URL) of the generated search result page to the terminal 200 and causes the terminal 200 to display the search result page.

Next, the recorder 110 records the search condition (step S104). Specifically, the recorder 110 stores, in the search condition storage 120, the search condition included in the search query received in step S101, in association with the user ID and the search timestamp. The recorder 110 adds a new record to the search condition table illustrated in FIG. 4, stores information in each item including “search ID,” “user ID,” “search timestamp,” and “search condition,” updates the search condition table, and completes the search condition recording process.

### Notification Process

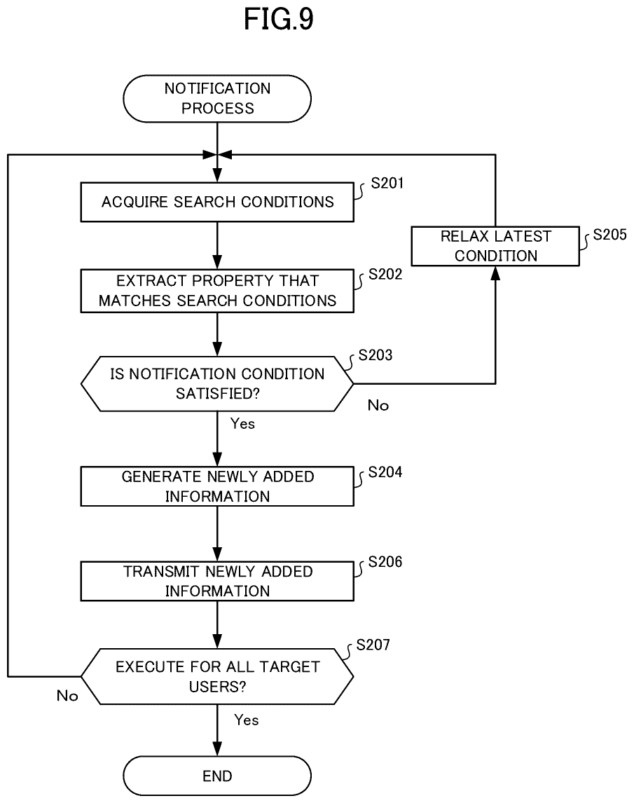

Next, a notification process for notifying the user of newly added information 220 by the search device 100 is described with reference to FIG. 9. The notification process may be executed at a preset interval, such as daily, every three days, or weekly, or at a predetermined timing, for example, when it is detected that property information of a new real estate property has been registered in the database 130.

The acquirer 141 acquires a search condition (step S201). Specifically, the acquirer 141 reads the latest condition stored in the storage 14 and refers to the search condition table illustrated in FIG. 4 to acquire a search condition that satisfies the latest condition from the history of search conditions previously entered by the target user. For example, when the number to retrieve is set to 3 in the latest condition, the acquirer 141 acquires three search conditions having the most recent search timestamps among the search conditions associated with the user id of the target user.

Next, the extractor 142 extracts property information of real estate properties that match the search condition acquired in step S201 (step S202). Specifically, the extractor 142 searches the database 130 illustrated in FIG. 5 and extracts property information of real estate properties that match the acquired search condition.

Next, the notifier 150 determines whether the notification condition is satisfied (step S203). Specifically, the notifier 150 reads the notification condition including the minimum number of real estate properties extracted in step S202 from the storage 14, and determines whether the number of the extracted properties extracted in step S202 is equal to or greater than the minimum number.

When the number of the real estate properties extracted in step S202 is equal to or greater than the minimum number, the notifier 150 determines that the notification condition is satisfied (Yes in step S203), and the process proceeds to step S204.

On the other hand, when the number of the extracted properties in step S202 is less than the minimum number, the notifier 150 determines that the notification condition is not satisfied (No in step S203), notifies the acquirer 141 accordingly, and the process proceeds to step S205.

In step S205, the acquirer 141 relaxes the latest condition (step S205). The acquirer 141 relaxes the latest condition based on a preset rule, for example, by changing the latest condition from acquiring the three search conditions with the most recent search timestamps to acquiring the five search conditions with the most recent search timestamps. The method of relaxing the latest condition may be arbitrary, and the number to retrieve may be increased by a predetermined number or by a predetermined multiple.

Next, the process returns to step S201 and the acquirer 141 reacquires the search condition based on the latest condition relaxed in step S205 (step S201). Next, in step S202, the extractor 142 extracts, from the database 130, property information of real estate properties that match the search condition reacquired in step S201 (step S202). Next, in step S203, the notifier 150 determines whether the real estate properties re-extracted by the extractor 142 satisfy the notification condition.

In this manner, the acquirer 141 and the extractor 142 repeatedly execute a series of processes including relaxing the latest condition, acquiring the search condition, and extracting the property information of the real estate properties, until the notifier 150 determines in step S203 that the notification condition is satisfied. The notification condition may include an upper limit of the number of repetitions of the series of these processes, and the notifier 150 may determine not to notify the user of the newly added information 220 when the number of repetitions reaches the upper limit.

Next, in step S204, the notifier 150 generates the newly added information 220 including the property information of the real estate properties extracted in step S202 (step S204). For example, as illustrated in FIG. 6, the notifier 150 generates the newly added information 220 by arranging, for each extracted real estate property, an exterior image 22, property information, a link 23 to a detail page, and a link 24 to an inquiry page.

Next, the notifier 150 transmits the newly added information generated in step S204 (step S206). Specifically, the notifier 150 transmits the generated newly added information to the terminal 200 by any method, such as email, messaging application, in-app notification, or push notification.

Next, the notifier 150 determines whether the notification process has been executed for all the target users (step S207). When the notifier 150 determines that the notification process has been executed for all the target users (Yes in step S207), the notification process is terminated.

On the other hand, when the notifier 150 determines that there remain users yet to be processed (No in step S207), the process returns to step S201, and the processes from step S201 to step S206 are executed for the unprocessed users.

As described above, the search device 100 records the search condition included in the search query transmitted from the terminal 200, and at a predetermined timing, acquires from among the history of search conditions a search condition that satisfies a latest condition defining the number of most recently entered search conditions to retrieve. The search device 100 searches for newly registered transaction targets in the database 130 based on the acquired search condition. The search device 100 repeatedly executes a series of processes including relaxing the latest condition, acquiring a search condition that satisfies the latest condition, and searching for information provision targets that meet the search condition, until the search result satisfies the notification condition, and generates the newly added information 220 to notify the user. Thus, since the search device 100 notifies the user of the newly added information 220 based on the user's latest interest, it becomes possible to more appropriately notify the user of newly added information 220 that is likely to be of interest.

Furthermore, since the search device 100 automatically records the search condition included in the search query transmitted from the terminal 200 and uses the search condition for the search to generate the newly added information 220, the user can avoid the need to explicitly set the search condition used for notification of the newly added information 220.

### Modified Example

In the above embodiment, the acquirer 141 is described as acquiring a search condition that satisfies the latest condition defining the number of the most recently entered search conditions to retrieve, but is not limited thereto. The acquirer 141 may classify the search conditions stored in the search condition storage 120 into multiple groups based on implication relationships, select the group with the most recent input timing among the classified groups, and acquire the search condition having the smallest inclusion range (i.e., the strictest condition) within the selected group.

For example, the acquirer 141 classifies the search conditions into multiple groups g₁, g₂, . . . , g_{G} (where G is a natural number) for each nearest station. Here, the acquirer 141 determines the order of the groups g₁, g₂, . . . , g_{G} based on the latest each time within each group. Each group gᵢ includes search conditions p_{i,1}, p_{i,2}, . . . , p_{i,p[i]}, and the implication relationship p_{i,1} p_{i,2} . . . p_{i-1,p[i-1]} p_{i,p[i]} holds. That is, the search condition p_{i,1} has the smallest inclusion range in group gᵢ, and the search condition p_{i,p[i]} has the largest inclusion range in group gᵢ.

When the number to retrieve included in the latest condition is 3, in step S201, the acquirer 141 extracts g₁, g₂, and g₃, which are the most recent search time in the classified group. Next, the acquirer 141 acquires the search conditions p_{1,1}, p_{2,1}, and p_{3,1} with the smallest inclusion ranges from each of the extracted groups g₁ to g₃. Thereafter, in step S202, the extractor 142 may search for property information of real estate properties that match the search conditions p_{1,1}, p_{2,1}, and p_{3,1}, respectively.

In the process of relaxing the latest condition in step S205, the acquirer 141 may relax the condition by acquiring, from each of the previously classified groups g₁ to g₃, the search conditions p_{1,2}, p_{2,2}, and p_{3,2} with the next smallest inclusion ranges following the search conditions p_{1,1}, p_{2,1}, and p_{3,1} acquired in the previous acquisition process. Then, the series of processes including relaxing the latest condition, acquiring the search condition, and extracting the real estate properties may be repeatedly executed until a determination is made in step S203 that the notification condition is satisfied.

The method for grouping search conditions may be arbitrary. For example, each search condition may be vectorized numerically to calculate similarity scores and the search conditions may then be classified using any clustering method, such as the K-means method or hierarchical clustering.

The search device 100 according to the above embodiment may be implemented using a general-purpose computer rather than a dedicated device. For example, the search device 100 that performs the above-described processing may be configured by installing, from a non-transitory recording medium storing a program to cause the computer to perform one of the above-described types of processing, the program in the computer. In addition, the search device 100 may be configured by a plurality of computers operating in collaboration with one another.

When the above functions are achieved by sharing of operation between an operating system (OS) and an application or by cooperation between the OS and the application, only a part other than the OS may be stored in the medium.

In addition, it is possible to superimpose programs on a carrier wave and distribute the programs via a communication network. For example, the programs may be distributed at an app store for a smartphone or the programs may be posted on a bulletin board system (BBS) on the communication network and distributed via the network. Then, these programs may be configured to perform the above processing by starting and executing the programs in a manner similar to other application programs under the control of the OS.

In addition, information stored in the storage 14 may be collectively managed by a cloud server existing on the network, and the search device 100 may access the cloud server and perform reading and writing of information on a needed basis. In this case, the search device 100 does not have to include the search condition storage 120 or the database 130. The search condition recording process and notification process by the search device 100 may be executed on the cloud using information stored in the cloud server.

The various aspects of the present disclosure are described as Appendices.

### Appendix 1

A search device for searching for a transaction target that matches search conditions entered by a user, from among a plurality of transaction targets registered in a database, the search device comprising:
at least one processor configured to
   record the entered search conditions,
   acquire, from among the recorded search conditions, a search condition that satisfies a latest condition for acquiring predetermined search conditions entered most recently,
   extract, from new transaction targets newly registered in the database, a transaction target that matches any of the acquired search conditions, and
   determine whether or not the extracted transaction target satisfies a notification condition that includes a minimum number of the transaction targets,
   when determining that the notification condition is satisfied, notify the user of the extracted transaction target, and
   when determining that the notification condition is not satisfied, repeatedly execute a series of processes including relaxing the latest condition and acquiring the search condition, and extracting the transaction target that matches any of the search conditions, until a determination is made that the notification condition is satisfied.

### Appendix 2

The search device according to Appendix 1, wherein
in the process of relaxing the latest condition and acquiring the search condition, the at least one processor relaxes the latest condition by increasing a number to retrieve, and acquires a search condition that satisfies the new relaxed latest condition.

### Appendix 3

The search device according to Appendix 1, wherein
the at least one processor classifies the recorded search conditions into groups based on an implication relationship, selects, from the classified groups, a number of groups equal to a number to retrieve and including most recently entered search conditions, and acquires the search condition from each of the selected groups.

### Appendix 4

The search device according to Appendix 3, wherein
the at least one processor
   assigns an order to the search conditions included in the classified groups, based on ascending inclusion range,
   in a first process of acquiring the search condition that satisfies the latest condition, acquires, from each of the classified groups, search conditions with the smallest inclusion range, and
   in a process of relaxing the latest condition and acquiring the search condition, acquires, from each of the classified groups, search conditions with the next smallest inclusion ranges following the search conditions acquired in the previous process of acquiring the search conditions.

### Appendix 5

The search device according to any one of Appendices 1 to 4, wherein
the notification condition includes an upper limit of a number of executions to repeatedly execute the series of processes, and
the at least one processor determines not to provide notification when the number of executions of the series of processes reaches the upper limit.

### Appendix 6

A search method comprising:
by a computer to search for a transaction target that matches search conditioned entered by a user, from a plurality of transaction targets registered in a database,
recording the entered search conditions;
acquiring, from among the recorded search conditions, a search condition that satisfies a latest condition for acquiring predetermined search conditions entered most recently;
extracting, from new transaction targets newly registered in the database, a transaction target that matches any of the acquired search conditions;
determining whether or not the extracted transaction target satisfies a notification condition that includes a minimum number of the transaction targets;
when determining that the notification condition is satisfied, notifying the user of the extracted transaction target; and
when determining that the notification condition is not satisfied, repeatedly executing a series of processes including relaxing the latest condition and acquiring the search condition, and extracting the transaction target that matches any of the search conditions, until a determination is made that the notification condition is satisfied.

### Appendix 7

A non-transitory computer-readable recording medium storing a program for causing a computer to execute processing comprising:
by a computer to search for a transaction target that matches search conditioned entered by a user, from a plurality of transaction targets registered in a database,
recording the entered search conditions;
acquiring, from among the recorded search conditions, a search condition that satisfies a latest condition for acquiring predetermined search conditions entered most recently;
extracting, from new transaction targets newly registered in the database, a transaction target that matches any of the acquired search conditions;
determining whether or not the extracted transaction target satisfies a notification condition that includes a minimum number of the transaction targets;
when determining that the notification condition is satisfied, notifying the user of the extracted transaction target; and
when determining that the notification condition is not satisfied, repeatedly executing a series of processes including relaxing the latest condition and acquiring the search condition, and extracting the transaction target that matches any of the search conditions, until a determination is made that the notification condition is satisfied.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The present disclosure can be preferably applied to a search device, a search method, and a recording medium capable of ensuring more appropriate notification of newly added information that is likely to be of interest to a user.

1. A search device for searching for a transaction target that matches search conditions entered by a user, from among a plurality of transaction targets registered in a database, the search device comprising:
at least one processor configured to
record the entered search conditions,
acquire, from among the recorded search conditions, a search condition that satisfies a latest condition for acquiring predetermined search conditions entered most recently,
extract, from new transaction targets newly registered in the database, a transaction target that matches any of the acquired search conditions,
determine whether or not the extracted transaction target satisfies a notification condition that includes a minimum number of the transaction targets,
when determining that the notification condition is satisfied, notify the user of the extracted transaction target, and
when determining that the notification condition is not satisfied, repeatedly execute a series of processes including relaxing the latest condition and acquiring the search condition, and extracting the transaction target that matches any of the search conditions, until a determination is made that the notification condition is satisfied.

2. The search device according to claim 1, wherein
in the process of relaxing the latest condition and acquiring the search condition, the at least one processor relaxes the latest condition by increasing a number to retrieve, and acquires a search condition that satisfies the new relaxed latest condition.

3. The search device according to claim 1, wherein
the at least one processor classifies the recorded search conditions into groups based on an implication relationship, selects, from the classified groups, a number of groups equal to a number to retrieve and including most recently entered search conditions, and acquires the search condition from each of the selected groups.

4. The search device according to claim 3, wherein
the at least one processor
assigns an order to the search conditions included in the classified groups, based on ascending inclusion range,
in a first process of acquiring the search condition that satisfies the latest condition, acquires, from each of the classified groups, search conditions with the smallest inclusion range, and
in a process of relaxing the latest condition and acquiring the search condition, acquires, from each of the classified groups, search conditions with the next smallest inclusion ranges following the search conditions acquired in the previous process of acquiring the search conditions.

5. The search device according to claim 1, wherein
the notification condition includes an upper limit of a number of executions to repeatedly execute the series of processes, and
the at least one processor determines not to provide notification when the number of executions of the series of processes reaches the upper limit.

6. A search method comprising:
by a computer to search for a transaction target that matches search conditioned entered by a user, from a plurality of transaction targets registered in a database,
recording the entered search conditions;
acquiring, from among the recorded search conditions, a search condition that satisfies a latest condition for acquiring predetermined search conditions entered most recently;
extracting, from new transaction targets newly registered in the database, a transaction target that matches any of the acquired search conditions;
determining whether or not the extracted transaction target satisfies a notification condition that includes a minimum number of the transaction targets;
when determining that the notification condition is satisfied, notifying the user of the extracted transaction target; and
when determining that the notification condition is not satisfied, repeatedly executing a series of processes including relaxing the latest condition and acquiring the search condition, and extracting the transaction target that matches any of the search conditions, until a determination is made that the notification condition is satisfied.

7. A non-transitory computer-readable recording medium storing a program for causing a computer for searching for a transaction target that matches search conditions entered by a user, from among a plurality of transaction targets registered in a database, to execute processing of:
recording the entered search conditions;
acquiring, from among the recorded search conditions, a search condition that satisfies a latest condition for acquiring predetermined search conditions entered most recently;
extracting, from new transaction targets newly registered in the database, a transaction target that matches any of the acquired search conditions;
determining whether or not the extracted transaction target satisfies a notification condition that includes a minimum number of the transaction targets;
when determining that the notification condition is satisfied, notifying the user of the extracted transaction target; and
when determining that the notification condition is not satisfied, repeatedly executing a series of processes including relaxing the latest condition and acquiring the search condition, and extracting the transaction target that matches any of the search conditions, until a determination is made that the notification condition is satisfied.
